(19) United States
(12) Patent Application Publication
(10) Pub. No.: US 2023/0143148 A1
(43) Pub. Date: May 11, 2023

(54) LIGHTING DEVICE FOR A MOTOR VEHICLE

(71) Applicant: HELLA GmbH & Co. KGaA, Lippstasdt (DE)

(72) Inventor: Martin MUEGGE, Geseke (DE)

(73) Assignee: HELLA GmbH & Co. KGaA, Lippstasdt (DE)

(21) Appl. No.: 17/981,901

(22) Filed: Nov. 7, 2022

(30) Foreign Application Priority Data
Nov. 8, 2021 (DE) 10 2021 128 935.1

(51) Int. Cl. F21S 43/20; F21S 43/237; F21S 43/245

(52) U.S. Cl. CPC F21S 43/26; F21S 43/237; F21S 43/245; F21Y 2115/10

(57) ABSTRACT

A lighting device for a motor vehicle, comprising a light source from which light is emitted during operation of the lighting device, a rod-shaped light guide which has a light entry surface on an end face for the light emitted from the light source and a light exit surface from which, during operation of the lighting device, the light which has entered through the light entry surface exits at least partially. The lighting device is set up to serve as a direction indicator, and wherein the lighting device comprises a controllable cover which is arranged at least partially in front of the light exit surface such that, during operation of the lighting device, at least a portion of the light exiting from the light exit surface enters an entry surface of the cover and exits from an exit surface of the cover.

This nonprovisional application claims priority under 35 U.S.C. § 119(a) to German Patent Application No. 102021128935.1, which was filed in Germany on Nov. 8, 2021, and which is herein incorporated by reference.

### BACKGROUND OF THE INVENTION

### Field of the Invention

The present invention relates to a lighting device for a motor vehicle. The present invention further relates to a headlight and a rear light for a motor vehicle having such a lighting device.

### Description of the Background Art

A lighting device is known from DE 41 29 094 A1, which is incorporated herein by reference. The lighting device comprises a light-emitting diode (LED) serving as a light source and an elongated, rod-shaped light guide into which the light emitted from the light-emitting diode can be coupled at the end face. The light guide has a light exit surface which extends over the longitudinal extent of the rod-shaped light guide and opposite which a surface is arranged which is provided with prisms and which deflects the light, moving through the light guide, to the light exit surface. The lighting device can be set up to serve as a direction indicator.

For flashing light functions, the flashing behavior is possible in two variants. On the one hand, the flashing light can be switched on and off altogether, resulting in a conventional turn signal or direction indicator. On the other hand, the flashing light can be made in the form of a sequentially switched running light flashing light. This sequential flashing is also known as a sweeping turn signal. It provides greater emphasis and therefore a greater safety of recognizability in road traffic.

Sequential control of the turn signal is easily possible for lighting systems formed of individual reflectors or lenses such as Fresnel lenses or individual light guide elements.

However, certain stylistic forms and implementations of headlights provide for an elongated, rod-shaped light guide as the lighting system, primarily for reasons of homogeneous illumination, as is the case, for example, with the lighting device known from DE 41 29 094 A1. A rod-shaped light guide is usually illuminated from one end face, usually on the outside of the vehicle, by one or more light-emitting diodes and then lights up as a whole as a functional surface.

Segmentation into individual sequentially illuminated regions in such a system is not known from the prior art.

### SUMMARY OF THE INVENTION

It is therefore an object of the present invention to provide a lighting device, which, despite the use of a rod-shaped light guide and coupling of the light into the light guide at an end face, enables a sequential flashing light function, in particular a sequential running light flashing function. Furthermore, a headlight and a rear light for a motor vehicle having such a lighting device are to be set forth.

According to an exemplary embodiment, it is provided that the lighting device comprises a controllable cover which is arranged at least partially in front of the light exit surface such that, during operation of the lighting device, at least a portion of the light exiting from the light exit surface enters an entry surface of the cover and exits from an exit surface of the cover, wherein the lighting device is set up to control the cover to selectively allow portions of the light incident on the entry surface to pass through the cover and not to allow other portions of the light incident on the entry surface to pass through the cover. By using a controllable cover, it is possible to selectively influence which portions of the light exiting from the light guide exit the lighting device.

It can be provided that the cover has a plurality of segments which can be controlled independently of one another. In particular, in this regard the cover can be controlled so that individual segments, especially segments adjacent in the direction of the longitudinal extent of the rod-shaped light guide, allow portions of the light incident on the entry surface to pass through the cover sequentially in time. This design enables a sequential flashing light function, especially a sequential running light flashing function.

There is a possibility that the cover is an LC display. An LC display can be selectively controlled to allow individual portions of the light emitted from the light guide to pass and not to allow other portions to pass through the LC display. If the LC display is also activated when the light guide function is activated and, for example, turns transparent in a function similar to running lights, this appears to an observer as sequential switching on or sequential switching off and thus as a sweeping turn signal.

It can be provided in this case that the LC display is a passive LC display. For an automotive lighting function, small areas are usually used, from which a high light output or a high brightness must be realized. For this reason, a high transmittance of the LC display is important to generate the legally required luminous intensities of a signal function. In contrast to an active LC display, a passive LC display does not have any active components such as transistors, for example, so that the transmittance of the passive LC display is significantly greater than that of an active LC display. Furthermore, a passive LC display can be manufactured much more cost-effectively than an active LC display. Any pixelation of the LC display that can be designed as desired is also advantageous with a passive LC display. The separately switchable pixels of the LC display can thereby be given any different shape and size, and thus actively define the desired design of a switchable matrix for the light function.

It is possible that the LC display is a guest-host display or a SmartGlass display. No polarizing filters are needed with such an LC display, so that a higher transmittance is available, which is advantageous for fulfilling the desired lighting function, for example, with a narrow rod-shaped light guide. Furthermore, the LC display is also viewing angle independent due to the omission of the polarizers.

It can be provided in this case that the LC display is an LC display doped with color pigments. In particular, the LC display in this case can be a so-called dye-doped display, which is doped with color pigments which determine the color of the LC display in its non-operational state. Thus, for example, a black region can be visible in the non-operational state, but so can a red or blue region or a region in any desired other color.

It is possible for the light guide to have structures, in particular structures formed as prisms, which deflect the light, entering through the light entry surface, in the direction of the light exit surface during operation of the lighting device, so that at least portions of the light, deflected in the direction of the light exit surface, exit from the light exit surface. In particular, the structures are arranged on the light guide side opposite the light exit surface. The specific design of the structures, especially those made as prisms, influences the performance and illumination quality of the light guide.

It can be provided that the light guide and/or the cover are bent at least in sections. In particular, the rod-shaped light guide and the cover arranged in front of the light guide can be adapted to the respective design of the environment, therefore, for example, to the design of a headlight or a rear light, by means of suitable curvatures and bends.

It is provided that the headlight comprises a lighting device of the invention.

It is provided that a rear light of, for example, a motor vehicle, comprises a lighting device of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic front view of a first embodiment of a lighting device of the invention;

FIG. 2 shows a schematic front view of a second embodiment of a lighting device of the invention;

FIG. 3 shows a side view of the light guide of the first embodiment of a lighting device of the invention;

FIG. 4 shows a side view of the light guide of a third embodiment of a lighting device of the invention;

FIG. 5 shows a side view of the first embodiment of a lighting device of the invention;

FIG. 6 shows a side view of the third embodiment of a lighting device of the invention;

FIG. 7 shows a side view of the third embodiment of a lighting device of the invention with illustrated segments on the cover;

FIG. 8 shows a side view of a fourth embodiment of a lighting device of the invention with illustrated segments on the cover;

FIG. 9 shows a side view of a fifth embodiment of a lighting device of the invention with illustrated segments on the cover;

FIG. 10 shows a side view of a sixth embodiment of a lighting device of the invention with illustrated segments on the cover; and

FIG. 11 shows a side view of a seventh embodiment of a lighting device of the invention with illustrated segments on the cover.

### DETAILED DESCRIPTION

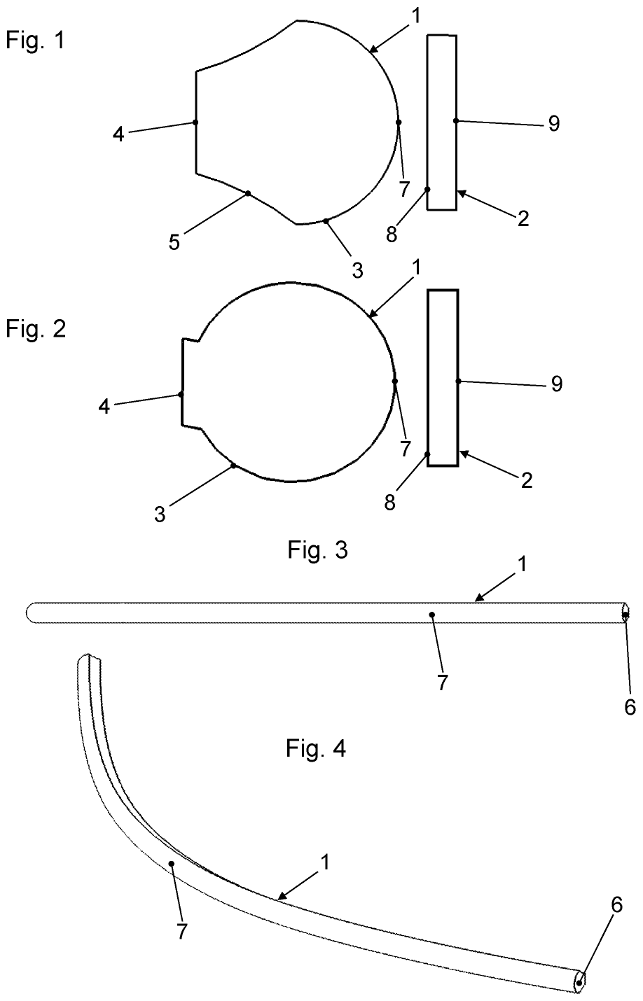

The lighting device shown in the figures comprises a light source, a rod-shaped light guide 1, and a cover 2 (see, for example, FIG. 1 and FIG. 2). The light emitted from the light source can enter light guide 1 at an end face and exit light guide 1 at the side. Cover 2 is arranged in front of light guide 1 on the exit side.

The light source can have one or more light-emitting diodes. It is further possible that an optical system, in particular a collimating lens, is arranged between the at least one light-emitting diode and light guide 1.

The cross section of the rod-shaped light guide 1 can, for example, is formed predominantly of a circular convex section 3 and additionally have a planar section 4 (see FIG. 2). Alternatively, the cross section of the rod-shaped light guide 1 can have concave sections 5 in addition to the circular convex section 3 and planar section 4 (see FIG. 1), wherein concave sections 5 can have substantially the shape of an exit-side end of a trumpet.

It is entirely possible that the rod-shaped light guide 1 has a different cross section.

The cross section of light guide 1 remains substantially the same along the longitudinal extent of light guide 1. Light guide 1 can extend longitudinally in a non-changing direction (see FIG. 3). Alternatively, light guide 1 can also be bent so that the direction of the longitudinal extent of light guide 1 changes, in particular changes over larger parts of the longitudinal extent (see FIG. 4).

It is entirely possible for light guide 1 to have a different shape and/or a different course, wherein the shape and course of light guide 1 can be adapted to the particular design of the environment, thus, for example, to the design of a headlight or a rear light.

The rod-shaped light guide 1 has a light entry surface 6 on an end face for the light emitted from the light source (see FIG. 3 and FIG. 4). It is entirely possible for light guide 1 to have a light entry surface 6 at both end faces, wherein a light source can then be positioned in front of each light entry surface 6.

The rod-shaped light guide 1 further has a light exit surface 7 which is arranged in the circular convex section 3 and is opposite to planar surface 4. Light exit surface 7 extends in particular over the entire length of light guide 1. To cause or enhance the exit of light from light exit surface 7, planar surface 4 has structures (not shown) formed as prisms. The prisms in this case can be oriented in particular transversely to the longitudinal extent of light guide 1.

These prism optics reflect light incident on them in light guide 1 in the direction of light exit surface 7, so that it can exit light guide 1 and light guide 1 lights up. The size, design, and distribution of the prism optics influence the performance and illumination quality of light guide 1. When the light source is switched on, the entire light guide 1 lights up over its entire length, wherein the structures are designed in particular such that the light guide lights up relatively homogeneously over its entire length.

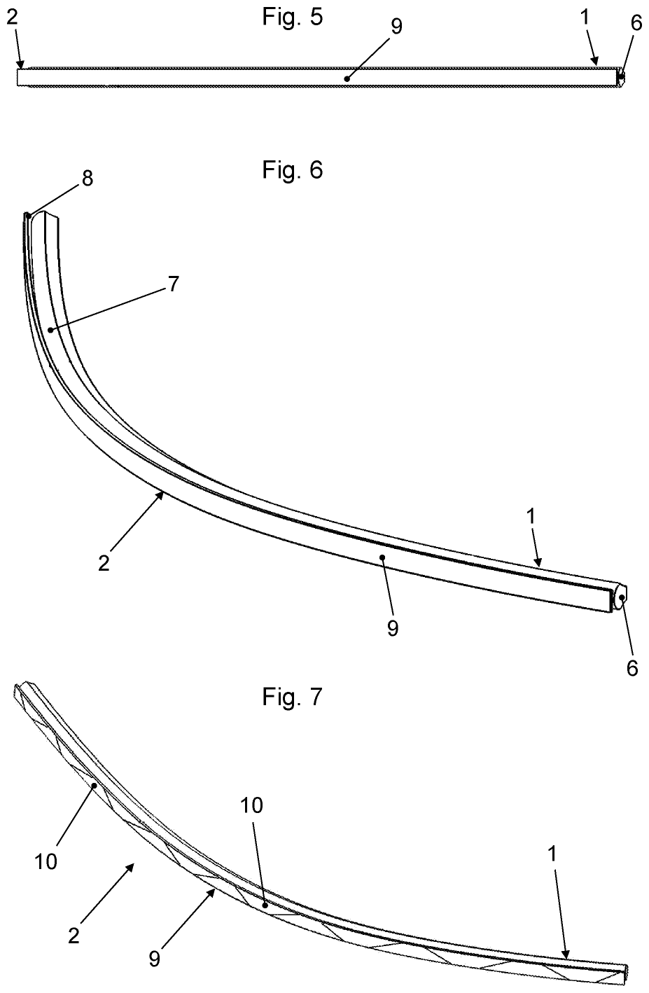

Cover 2 has an entry surface 8 and an exit surface 9. Cover 2 is positioned in front of light guide 1 such that the light exiting from light exit surface 7 of light guide 1 impinges in particular completely on entry surface 8 of the cover (see FIG. 1, FIG. 2, FIG. 5, and FIG. 6). In the figures, cover 2 is positioned relatively close in front of light exit surface 7 of light guide 1. It is entirely possible to provide a larger or smaller distance between light exit surface 7 of light guide 1 and entry surface 8 of cover 2.

Cover 2 is designed as a switchable cover 2. Cover 2 is divided into a plurality of segments 10 (see FIG. 7). It is possible to selectively control each of the segments 10 to allow light entering entry surface 8 in the region of that segment 10 to either exit through exit surface 8 or not to exit through exit surface 8.

Cover 2 is a passive LC display, which is designed as a so-called SmartGlass display or guest-host display. In particular, the LC display in this case can be a so-called dye-doped display, which is doped with color pigments which determine the color of the LC display in its non-operational state. The liquid crystals doped with color pigments (dye-doped liquid crystals) are enclosed between two substrate layers, in particular thin sheets of glass or plastic films that have an electrically conductive layer. Compared to conventional LC displays, an LC display of this type works without a polarizing filter and thus has a relatively high transmission. In an operational state (on-state), controlled segment 10 of the LC display serving as a cover 2 allows the light that has entered through the part of entry surface 8 of controlled segment 10 to exit at least partially, in particular for the most part, from exit surface 9, whereas in a non-operational state (off-state), controlled segment 10 of the LC display does not allow the light that has entered through the corresponding part of entry surface 8 to exit from exit surface 9.

The LC display can have different colors in the non-operational state or it can be made black. Because the LC display is black, for example, in the non-operational state, the light function can be hidden with a so-called black panel effect so that the individual segments 10 or the separations between segments 10 are barely visible. When switched on or transferred to the operational state (on-state), the LC display turns transparent so that the light guide function behind it can emit light unimpeded and fulfill the function of the direction indicator.

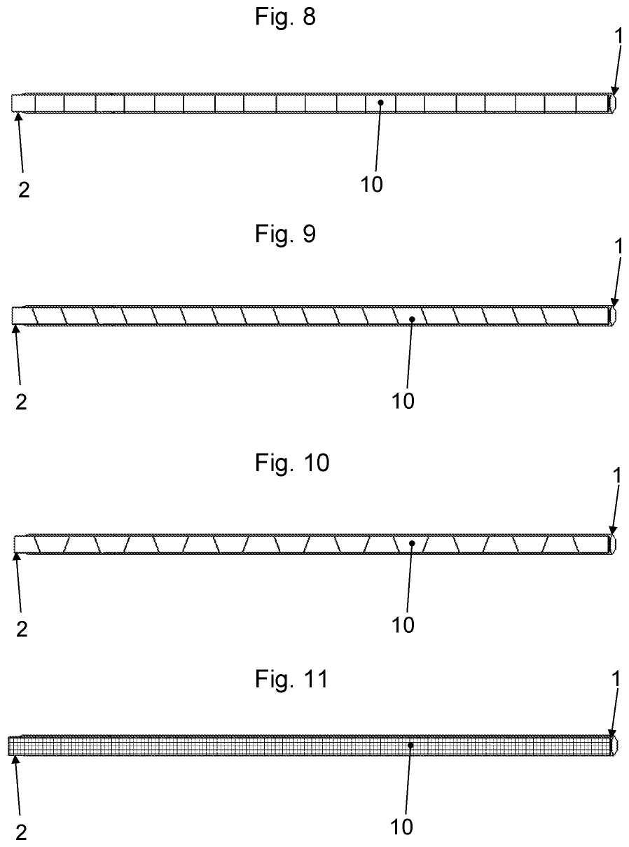

The LC display can have any segmentation and pixel size, which also provides different design options for different vehicle manufacturers. FIGS. 8 to 11 show exemplary segmentations with differently sized and differently arranged segments. It is entirely possible to provide segmentations other than those shown for the operating device. It is also possible to provide shapes of segments other than those shown. Both fine segmentations and coarse segmentations are possible.

If, with the activation of the light source, the LC display is also activated, wherein the individual segments 10 are activated sequentially in time or are turned transparent in a function similar to running lights or in the operational state, this appears to an observer as sequential switching on or sequential switching off and thus as a sweeping turn signal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lighting device for a motor vehicle, the lighting device comprising:
a light source from which light is emitted during operation of the lighting device;
a rod-shaped light guide that has a light entry surface on an end face for the light emitted from the light source and a light exit surface that extends at least in sections over a longitudinal extent of the rod-shaped light guide and from which, during operation of the lighting device, the light that has entered through the light entry surface exits at least partially; and
a controllable cover arranged at least partially in front of the light exit surface such that, during operation of the lighting device, at least a portion of the light exiting from the light exit surface enters an entry surface of the cover and exits from an exit surface of the cover,
wherein the lighting device is set up to control the cover to selectively allow portions of the light incident on the entry surface to pass through the cover and not to allow other portions of the light incident on the entry surface to pass through the cover, and
wherein the lighting device is set up to serve as a direction indicator.

2. The lighting device according to claim 1, wherein the cover has a plurality of segments adapted to be controlled independently of one another.

3. The lighting device according to claim 2, wherein the lighting device is set up to control the cover so that individual segments or segments adjacent in a direction of the longitudinal extent of the rod-shaped light guide allow portions of the light incident on the entry surface to pass through the cover sequentially in time.

4. The lighting device according to claim 1, wherein the cover is an LC display.

5. The lighting device according to claim 4, wherein the LC display is a passive LC display.

6. The lighting device according to claim 4, wherein the LC display is a guest-host display or a SmartGlass display.

7. The lighting device according to claim 4, wherein the LC display is an LC display doped with color pigments.

8. The lighting device according to claim 1, wherein the light guide or structures formed as prisms that deflect the light entering through the light entry surface in a direction of the light exit surface during operation of the lighting device, so that at least portions of the light, deflected in the direction of the light exit surface, exit from the light exit surface.

9. The lighting device according to claim 8, wherein the structures are arranged on the side of the light guide, the side of the light guide being opposite the light exit surface.

10. The lighting device according to claim 1, wherein the light guide and/or the cover are bent at least in sections.

11. A headlight for a motor vehicle comprising a lighting device according to claim 1.

12. A rear light for a motor vehicle comprising a lighting device according to claim 1.
